(19) United States
(12) Patent Application Publication
(10) Pub. No.: US 2016/0178241 A1
(43) Pub. Date: Jun. 23, 2016

(54) SOLAR MODULE CLEANER

(71) Applicant: SunPower Corporation, San Jose, CA (US)

(72) Inventors: Cedric Jeanty, Davis, CA (US); Benjamin Meeder, San Jose, CA (US); Devin Cameron Castellucci, Woodland, CA (US); Marc Grossman, Davis, CA (US); Juan Sanchez-Garcia, Woodland, CA (US); Erik Cummins, Sacramento, CA (US)

(21) Appl. No.: 14/671,877

(22) Filed: Mar. 27, 2015

Related U.S. Application Data
(60) Provisional application No. 62/095,561, filed on Dec. 22, 2014.

(51) Int. Cl. F24J 2/46; B08B 1/00

(52) U.S. Cl. CPC F24J 2/461; B08B 1/002; B08B 1/006

(57) ABSTRACT

A solar module cleaner can be configured for cleaning reflective surfaces of solar concentrator reflectors. The cleaner can include at least one cleaning module having a cleaning surface extending in a curved configuration corresponding to a curvature of the solar concentrator reflector. The cleaning surface can be configured to displace debris resting on the reflective surface. The cleaner can include fluid delivery devices for discharging a cleaning fluid onto the reflective surface. The cleaner can be configured to clean solar energy receivers associated with a solar concentrator reflector. Additionally, the cleaner can be configured to simultaneously clean a plurality of parallel solar concentrator reflectors. Optionally, the cleaner can be configured to simultaneously clean a plurality of solar energy receivers and a plurality of solar energy concentrators.

### CROSS REFERENCE TO RELATED APPLICATION

This application claims the benefit of U.S. Provisional Application No. 62/095,561 filed Dec. 22, 2014, entitled “Solar Module Cleaner” by Jeanty et al., the entire contents of which are hereby incorporated by reference.

### TECHNICAL FIELD

Embodiments of the subject matter described herein relate generally to devices for cleaning parts of solar energy systems, such as solar energy receivers as well as reflective devices such as solar concentrators.

### BACKGROUND

Photovoltaic (PV) cells, commonly known as solar cells, are well known devices for direct conversion of solar radiation into electrical energy. Generally, solar cells are fabricated on a semiconductor wafer or substrate using semiconductor processing techniques to form a p-n junction near a surface of the substrate. Solar radiation impinging on the surface of, and entering into, the substrate creates electron and hole pairs in the bulk of the substrate. The electron and hole pairs migrate to p-doped and n-doped regions in the substrate, thereby generating a voltage differential between the doped regions. The doped regions are connected to conductive regions on the solar cell to direct an electrical current from the cell to an external circuit. Solar cells can be coupled together electrically (e.g., in series) to form a solar, or PV, module.

In operation exposed to the ambient atmosphere, PV modules can collect dust, dirt, or other particulates, which can block some amount of solar radiation, which can ultimately reduce the amount of energy produced by the PV module.

### BRIEF SUMMARY

At least one of the inventions disclosed herein includes the realization that despite the complex geometry, highly water efficient devices can be used for cleaning concentrated solar energy reflectors. Concentrated solar energy systems have a more complex geometry due to the incorporation of curved reflectors that are designed to concentrate sunlight onto a narrowly defined area, while tracking movement of the sun. Some of the known techniques for cleaning concentrating reflectors of solar energy systems rely on manually directing jets of water, for example, with pressure washers, and manually wiping down the mirrors. This approach leads to large amounts of water being used to clean concentrators.

An aspect of at least one of the inventions disclosed herein includes the realization that close fitting and finely aligned devices having mounted brushes, squeegees, and water sprayers can be used to clean concentrating solar reflectors with less water than current approaches.

Thus, in some embodiments, a solar device cleaning mechanism includes a plurality of debris removal surfaces arranged along a sunlight concentrating curvature geometry and at least one guide configured to follow a reference surface of the reflector so as to maintain alignment of the debris removal surfaces during a cleaning process.

Another aspect of at least one of the inventions disclosed herein includes the realization that a solar device cleaning mechanism can be configured to clean both a solar energy reflector and a solar energy receiver, simultaneously. As such, the cleaning device provides for an increase in cleaning efficiency by cleaning multiple distinct surfaces, simultaneously. One reason why such a device is practicable is that solar energy concentrators have a specific, finite geometry for capturing and reflecting sunlight onto a specified receiver. Thus, in a single solar system, many concentrators, having the same curvature and angular orientation are mounted with a specific orientation such that the aperture of the reflector is accurately aligned with the solar energy receiver so as to focus light into the desired shape and intensity onto the receiver, during the desired range of movement of sun tracking motion during use. As such, in a single solar system using such concentrating hardware, many or all of the concentrating reflectors are precisely or nearly the same size and mounted in the same or nearly the same orientation relative to receivers which are similarly the same size and mounted in the same orientation relative to the associated concentrator. The geometry is relatively complex because the curved concentrators and the receivers face each other in a non-perpendicular orientation.

Thus, in some embodiments, a solar system cleaning device includes two distinct sets of debris removal surfaces. A first set includes a plurality of debris removal surfaces extending along a solar energy concentrating curvature and a second set of debris removal surfaces extend in a roughly opposite direction aligned along a solar receiver surface.

In some embodiments, a concentrated solar energy collector cleaner can comprise a frame member and a first cleaning module supported by the frame member, the first cleaning module can include at least a first debris displacing member having a first cleaning surface extending along a curved shape. A first guide member can be configured to support the frame member during a cleaning movement of the cleaner with the first cleaning surface of the first debris displacing member in contact with a first curved reflective surface of a first solar concentrator.

In some embodiments, a concentrated solar energy collector cleaner can comprise a frame member extending along a longitudinal direction and a first cleaning module supported by the frame member, the first cleaning module can include at least a first debris displacing member having a first cleaning surface extending along a first curved shape. A second cleaning module can be supported by the frame member, the first cleaning module including at least a second debris displacing member having a second cleaning surface extending along a second curved shape. The first and second cleaning modules can be spaced from each other along the longitudinal direction.

In some embodiments, a concentrated solar energy collector cleaner can comprise a frame member and means, supported by the frame member, for simultaneously cleaning a plurality of solar concentrating reflectors having parallel longitudinal axes, with a single movement of the frame member in a direction parallel to the longitudinal axes.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a side view of a prior art solar system;

FIG. 2 is a detailed side view of the solar system of FIG. 1;

FIG. 3 is a perspective view of the solar system of FIG. 1;

FIG. 4 is a perspective view of an embodiment of a cleaning device for a solar system;

FIG. 5 is another perspective view of the embodiment of FIG. 4;

FIG. 6 is a schematic elevational view of an optional arrangement of debris removal devices that can be included on one or more portions of the embodiment of FIG. 4, in a neutral state;

FIG. 7 is a schematic elevational view of the debris removal arrangement of FIG. 6, having the free ends of the removal devices pressed against a surface to be cleaned;

FIG. 8 is a schematic axial end view of the embodiment of FIG. 4 placed in operational position for cleaning one row of concentrators and receivers of the solar system of FIGS. 1-3;

FIG. 9 is a perspective view of the arrangement in FIG. 8;

FIG. 10 is a perspective view of another modification of the embodiment of FIG. 4 including a support frame, a debris removal assembly, and a guide assembly;

FIG. 11 is also a perspective view of the embodiment of FIG. 10, with the support frame and some of the wipers removed;

FIG. 12 is an enlarged perspective view of one of the debris removal and guide assemblies of the embodiment of FIG. 11;

FIG. 13 is a schematic axial end view of the embodiment of FIG. 10 in use for cleaning a solar system of FIGS. 1-3;

FIG. 14 is a perspective view of the arrangement in FIG. 13.

### DETAILED DESCRIPTION

The following detailed description is merely illustrative in nature and is not intended to limit the embodiments of the subject matter of the application or uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Terminology. The following paragraphs provide definitions and/or context for terms found in this disclosure (including the appended claims):

“Comprising.” This term is open-ended. As used in the appended claims, this term does not foreclose additional structure or steps.

“Configured To.” Various units or components may be described or claimed as “configured to” perform a task or tasks. In such contexts, “configured to” is used to connote structure by indicating that the units/components include structure that performs those task or tasks during operation. As such, the unit/component can be said to be configured to perform the task even when the specified unit/component is not currently operational (e.g., is not on/active). Reciting that a unit/circuit/component is “configured to” perform one or more tasks is expressly intended not to invoke 35 U.S.C. §112, sixth paragraph, for that unit/component.

“First,” “Second,” etc. As used herein, these terms are used as labels for nouns that they precede, and do not imply any type of ordering (e.g., spatial, temporal, logical, etc.). For example, reference to a “first” drive module of a PV module cleaner does not necessarily imply that this cleaning module is the first cleaning module in a sequence; instead the term “first” is used to differentiate this cleaning module from another cleaning module (e.g., a “second” cleaning module).

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

“Coupled”—The following description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically.

“Inhibit”—As used herein, inhibit is used to describe a reducing or minimizing effect. When a component or feature is described as inhibiting an action, motion, or condition it may completely prevent the result or outcome or future state completely. Additionally, “inhibit” can also refer to a reduction or lessening of the outcome, performance, and/or effect which might otherwise occur. Accordingly, when a component, element, or feature is referred to as inhibiting a result or state, it need not completely prevent or eliminate the result or state.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import.

Embodiments of cleaning devices for solar energy collection systems and methods of use are described herein. In the following description, numerous specific details are set forth, such as specific structures and operations, in order to provide a thorough understanding of embodiments of the present disclosure. It is apparent to one skilled in the art that embodiments of the present disclosure can be practiced without these specific details. In other instances, well-known structures or techniques are not described in detail, for brevity. Moreover, some details of robotic cleaners are described in commonly owned U.S. application Ser. No 13/745,722, entitled “Mechanism for Cleaning Solar Collector Surfaces” by Grossman et al., filed on Jan. 18, 2013, and U.S. Provisional Patent Application No. 62/007,381, entitled “Solar Module Cleaner” by Grossman et al., filed on Jun. 3, 2014, both of which are attached as appendices and form part of the present disclosure. Furthermore, it is to be understood that the various embodiments shown in the figures are illustrative representations and are not necessarily drawn to scale.

The present specification describes several types of known concentrated solar energy collection systems followed by descriptions of various embodiments of solar energy system cleaning devices as well as methods of using such cleaning devices. Various examples are provided throughout.

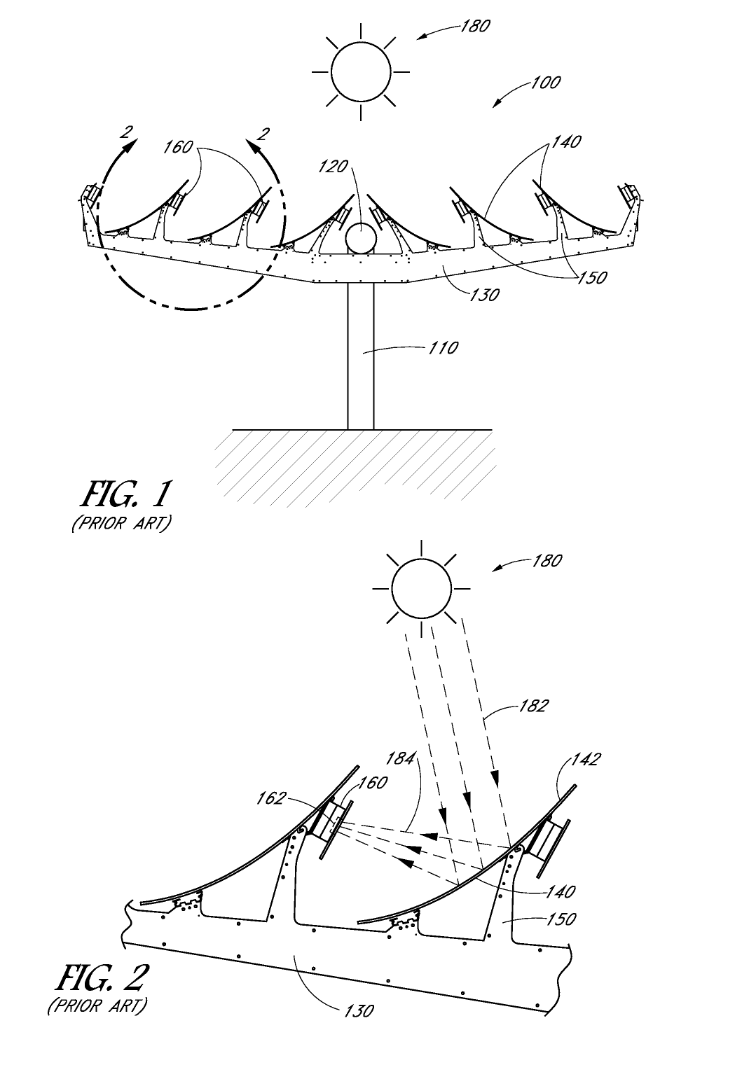

Turning now to the Figures, FIG. 1 illustrates a view of a prior art solar system 100 being irradiated by the sun 180. The solar system 100 is a concentrator system, although other solar systems can provide environments of use of the inventions disclosed herein.

The solar system 100 comprises a pier 110, a torque tube 120 supported by the pier 110, at least one cross beam 130 coupled to the torque tube 120. Several solar concentrators or reflector elements 140 are supported by a support structure 150 which couples to one or more of the cross beams 130. The support structure 150 couples one of the solar receivers 160 to one or more of the cross beams 130. In some embodiments, one or more of the solar receivers 160 can be coupled to the rear, non-reflective side of one or more solar concentrators 140. The torque tube 120 can rotate the assembled and positioned solar concentrators 140 and solar receivers 160 to track the sun during the day. By tracking the sun, the solar system 100 can receiver optimum irradiance during hours of sunlight.

The solar system 100 can adjust the position of the solar concentrators 140 to permit concentration of light from the sun 180 onto the solar receivers 160. The solar receivers 160 can be photovoltaic solar cells, or portions thereof, which convert the received sunlight into electrical current. Additional features can be incorporated into the solar system 100. For clarity and descriptive purposes, these are omitted.

The support structure 150 can refer to one or more components coupling the solar concentrators 140 to the cross beam 130, the solar receivers 160 to the cross beam 130, the solar receivers 160 to the solar concentrators 140, or a combination thereof. For example, the support structure 150 can refer to all components coupling the pier 110 to the solar receiver 160, including the torque tube 120, the cross beam 130, and, in some embodiments, the solar concentrators 140. The support structure 150 can refer to components which couple a solar receiver 160 to a solar concentrator 140, such as when a solar receiver 160 is mounted on the rear, non-reflective side of a solar concentrator 140. In still other embodiments, the support structure 150 can refer to components, members, or elements which couple a solar concentrator 140 to the cross beam 130. In still other embodiments, the support structure 150 can refer to components which couple a solar concentrator 140 to the torque tube 120 and can include one or several cross beams 130.

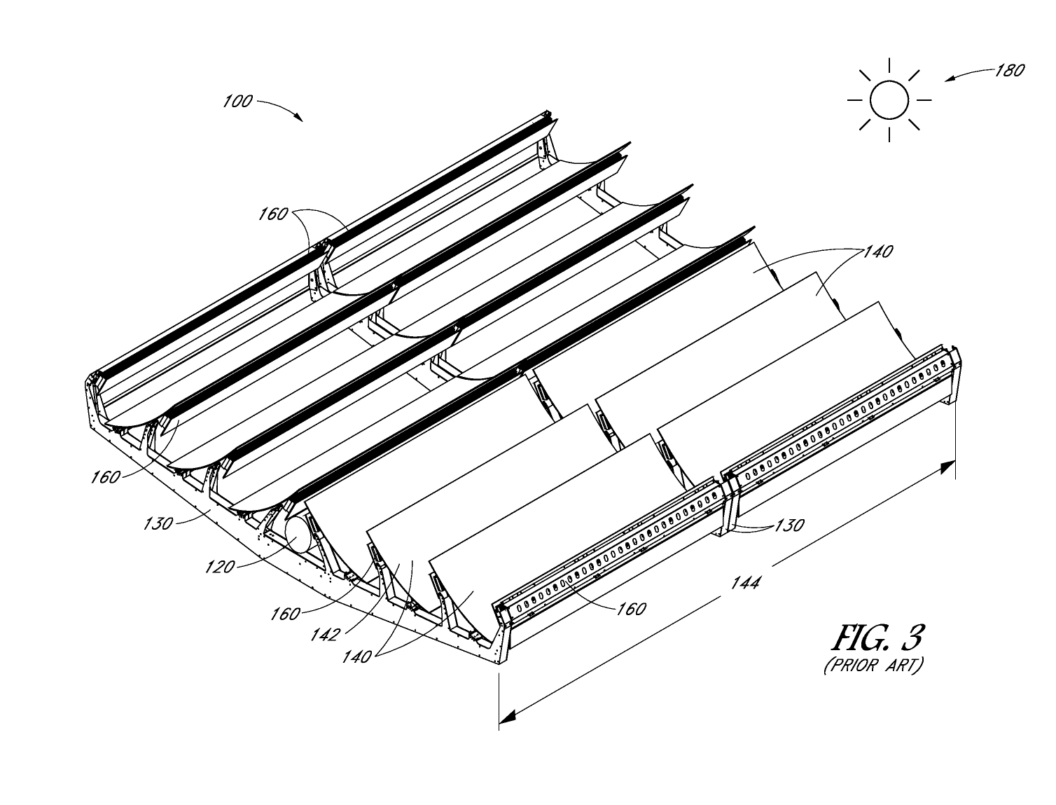

FIG. 2 is an enlarged, detailed view of a portion of the solar system 100 of FIG. 1. The solar concentrators 140 can have any of a number of shapes and sizes, such as the parabolic reflectors shown. The reflective surface 142 can receive sunlight 182 from the sun 180 and reflect and concentrate it into concentrated sunlight 184. The intensity of concentrated sunlight provided to a receiver, such as solar receiver 160, can be referred to by a measure of the intensity of illumination relative to unconcentrated sunlight. Thus, the solar concentrators 140 can be considered as having a sunlight concentrating curvature. For example, a concentrator which provides concentrated sunlight which has twice the intensity of unconcentrated sunlight is referred to as providing “two suns”. The illustrated solar concentrator 140 can provide eleven suns of concentrated sunlight on a receiver embodiment, although the amount of concentration can vary, from 2 to 50 suns. The solar system 100 can also operate without a solar concentrator 140, and the solar receiver 160 can receive unconcentrated sunlight.

The solar concentrator 140 directs the concentrated sunlight 184 to a predetermined location on the solar receiver 160. The solar receiver 160 includes a photovoltaic solar cell or a photovoltaic solar cell unit. The concentrated sunlight 184 preferably impinges on the solar cell 162 to enable electrical energy generation. The solar receiver 160 can include several components interoperating to produce electrical energy, such as interconnects connecting two or more photovoltaic solar cell units, an encapsulate, a carrier, a heat sink, and so on.

One face of the solar receiver 160 can be positioned to face toward the solar concentrator 140, thereby receiving the concentrated sunlight 184. This face preferably includes the photovoltaic solar cell 162 and can also include a protective layer over the photovoltaic solar cell 162. During use, the solar system 100 is positioned, for example, with a sun-tracking drive system (not shown) such that the concentrated sunlight 184 reflected by the solar concentrator 140 impinges on the photovoltaic solar cell 162, and not other portions of the solar receiver 160, thereby increasing the electrical output of the solar cell 162 and, consequently, overall system efficiency. FIG. 2 illustrates a position where the concentrated sunlight 184 is appropriately directed.

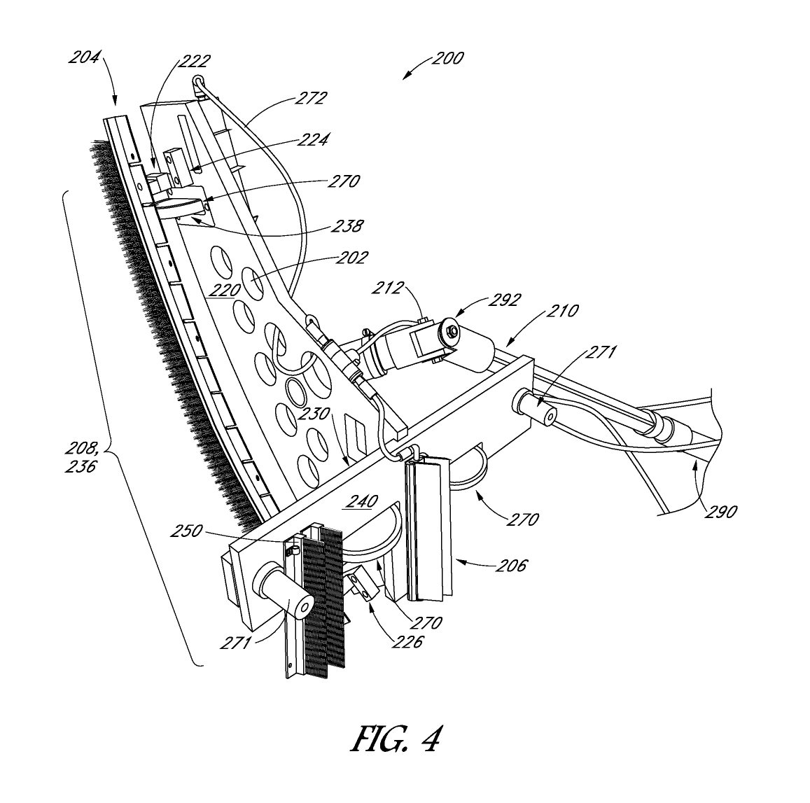

FIG. 3 illustrates a perspective view of the solar system 100. Several solar concentrators 140 can be arranged adjacent one another in the longitudinal axis of the concentrators 140, or direction 144. In this way, the solar system 100 can extend along the longitudinal direction 144 and expand its area of capture for photovoltaic electrical conversion. In addition to the solar concentrators 140, solar receivers 160 can be arranged to correspond to the position of the solar concentrators 140. Thus, adjacent solar receivers 160 can extend along the longitudinal direction 144.

Two or more adjacent sets of solar concentrators 140 with their corresponding solar receivers 160 can be present, increased to any desired number. For purposes of descriptive clarity, six sets of such concentrators 140 and solar receivers 160 are shown in FIG. 3. Additionally, the illustrated embodiments, elements, and components are not illustrated to scale, but rather shown in a particular arrangement, position, or magnification for descriptive purposes. In other concentrated solar system designs, a plurality of different rows of curved mirrors focus light onto a single row of receivers. Additionally, in some thermal solar systems, the thermal solar receivers are in the form of pipes containing an oil or molten salt and the concentrators have similar but different shapes and configurations.

As described herein, the light receiving surfaces of solar collection receivers 160, as well as the concentrators 140 can accumulate dirt, dust, or other particulates (e.g., airborne particulates) that can block light that would otherwise be incident on the collector surface. Such accumulation can reduce the potential power output of the solar collector(s).

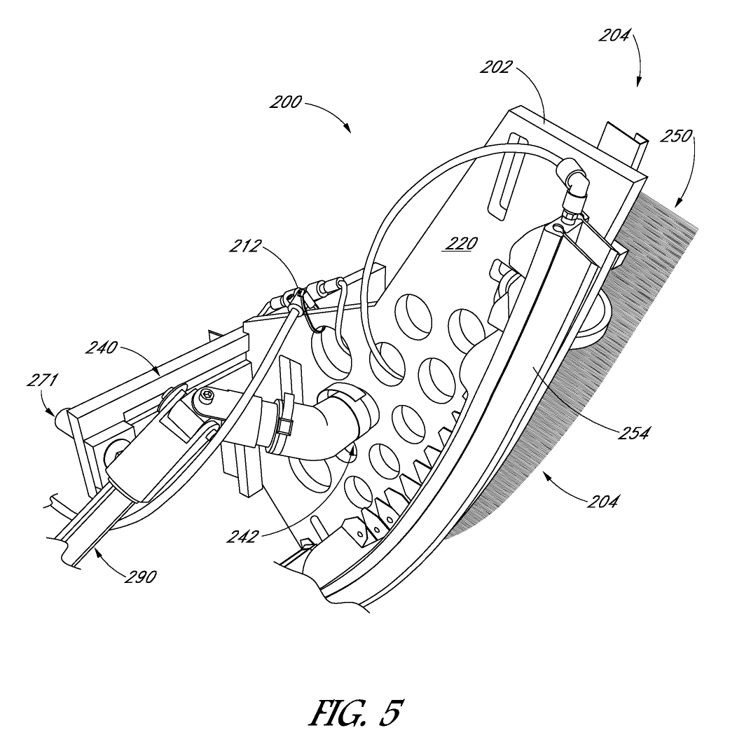

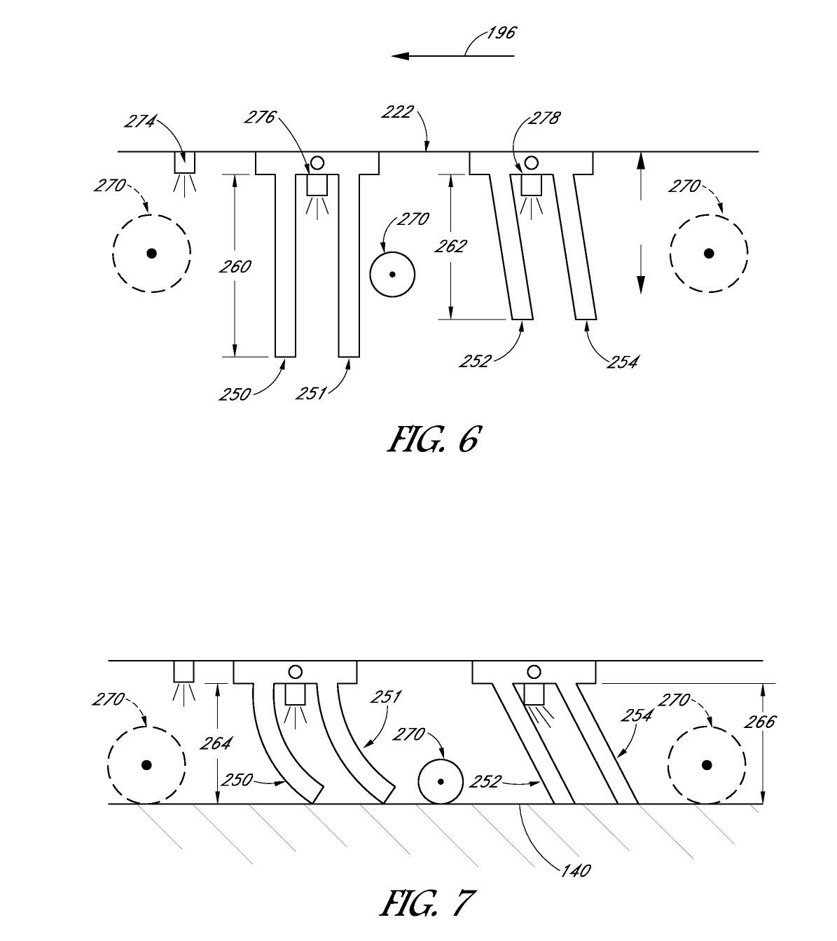

FIGS. 4 and 5 illustrate an embodiment of a cleaning device 200 for cleaning a solar system. The cleaning device 200 includes a support frame 202 configured for supporting at least one cleaning module 204. Optionally, the cleaning device 200 can also include a second cleaning module 206, which can also be connected to the frame 202. Further, optionally, the cleaning device 200 can include a guide device 208, optionally connected to and supported by the frame 202. Additionally, optionally, the cleaning device 200 can include a handle assembly 210 configured to accommodate application of a pushing or pulling force for moving the cleaning device 200 along the surface to be cleaned. Additionally, the cleaning device 200 can include a cleaning liquid delivery mechanism 212 configured to deliver a cleaning liquid during operation.

The frame 202 can be in any configuration, with sufficient stiffness and strength for supporting the desired components, which can include any combination of the devices 204, 206, 208, 210, 212, noted above, or other devices. In the illustrated embodiment, the frame 202 includes a body portion 220, a first cleaning module support portion 222, which in the illustrated embodiment, includes an upper support 224 and a lower support 226. Additionally, the frame 202 can include a second cleaning module support portion 230 configured for supporting the second cleaning module 206. The frame 202 also includes a guide support portion 236 which includes, in the illustrated embodiment, a roller support 238 and a cross member 240, described in greater detail below. As shown in FIG. 5, the frame 202 also includes a handle support 242 configured for providing a secure connection to the handle assembly 210.

In the illustrated embodiment, the body 220 of the frame 202 is made from a plate member, with a plurality of weight relieving holes. However, the frame 202 and a body 220 can be made in any configuration desired.

The cleaning device 200 can include one or more cleaning modules 204, 206 for cleaning portions of a solar energy system. As used herein, the term “cleaning module” is used interchangeably with the term “cleaning head.” The cleaning modules 204, 206 can include one or more components for removing accumulated particulate from surfaces of a solar energy system. For example, the cleaning modules 204, 206 can include rotating or fixed brushes, and/or one or more squeegees, and/or any other type of debris removal devices, which can be considered debris displacement devices or members, or any combination of the above.

The illustrated embodiments of the cleaning device 200 includes a “dual-squeegee” configuration described in more detail below. However, other squeegee arrangements can also be used, for example, single squeegee arrangements, or arrangements with no squeegees. One or more of the squeegees can function as a fluid removal element, for example, by removing fluids, such as cleaning liquids or other fluids, which may have debris suspended therein.

Additionally, the illustrated embodiment of the cleaning device 200 includes additional, optional, upstream brushes, which can be in the form of fixed single blade brushes, double brush assemblies, rotating brushes, or other types of brushes. One of more of the brushes can be configured to impart mechanical energy so as to loosen debris and suspend such debris in a clearing fluid, such as water or other cleaning liquids or fluids applied to the surfaces to be cleaned.

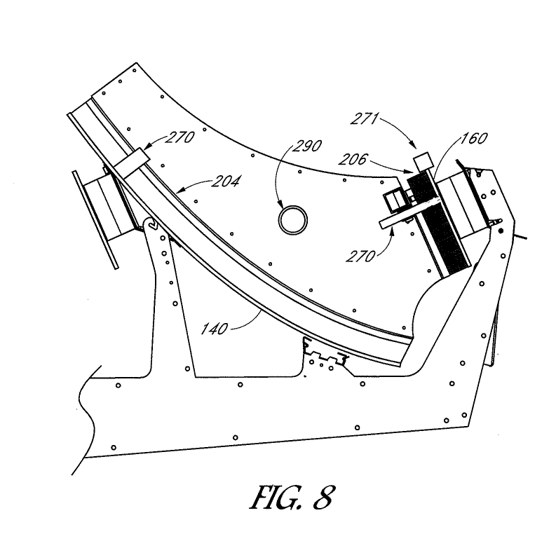

With continued reference to FIGS. 6 and 7, the first cleaning module 204 can include a first brush member 250, a first squeegee member 252, and a second squeegee member 254. In the illustrated arrangement, the first cleaning module 204 is arranged with the first brush member 250 arranged upstream from the squeegees 252, 254, relative to the intended direction of travel of the cleaning device 200 during use. However, other arrangements of the brush 250 and the squeegees 252, 254 can also be used.

The first cleaning module 204 is configured to remove debris from and thus clean a concentrating reflector, such as the reflectors 140 illustrated in FIGS. 1-3. Thus, as shown in FIGS. 4, 5, 8 and 9, the brush member 250 extends along a curved contour that approximately matches the curved contour of the concentrators 140. In some embodiments, the brush member 250 is mounted and configured to be compressed by approximately one-quarter of an inch during use. Thus, the brush member 250 can be mounted to the frame 202 such that the deformed shape, being compressed one-quarter of an inch from a relaxed state of the brush member 250, follows the contour of the concentrators 140.

Similarly, the first and second squeegees 252, 254, of the first cleaning module 204 can be mounted to the frame 202 so as to follow the contour of a surface to be cleaned, and in the present embodiment, the curvature of concentrators 140. Like the brush member 250, the squeegee members 252, 254 function more desirably when compressed from the relaxed state. With some squeegee designs, the squeegee members 252, 254 can be mounted to the frame 202 so as to be compressed by approximately one-eighth of an inch during use. Thus, the squeegee members 252, 254 can be mounted such that when they are compressed by approximately one-eighth of an inch, they follow the contour of the concentrators 140. This functionality is schematically illustrated in FIGS. 6 and 7.

As shown in FIGS. 6 and 7, the brush member 250 and the first and second squeegee members 252, 254 are supported by the frame at the first cleaning module support portion 222. Additionally, a second optional brush member 251 is also illustrated.

With reference to FIG. 6, the brush members 250, 251 have a length identified by the reference numeral 260. The length 260 represents the length of the brush members 250, 251 in a relaxed state. Additionally, FIG. 6 illustrates the squeegee members 252, 254, although mounted at a slight angle, have a length represented by the reference number 262. As noted above, it can be desirable to configure the cleaning device 200 such that the brush members 250, 251 are deflected by approximately one-quarter of an inch during use and such that the squeegee members 252, 254 are compressed or deflected by approximately one-eighth of an inch during use. Thus, as shown in FIG. 7, during use, when the cleaning device 200 is used for cleaning, for example, concentrators 140, the brush members 250, 251 are deflected to a length represented by the reference numeral 264 which is approximately one-quarter of an inch less than the length 260 and the squeegee members 252, 254 are deflected to a length represented by the reference numeral 266, which is approximately one-eighth of an inch less than the length 262. As such, the distal ends, or in other words the free ends furthest from the frame 202, of the brush members 250, 251 and the squeegee members 252, 254, can be considered cleaning surfaces.

Although, as noted above, any type of brush or squeegee members can be used for the device 200, some brush members 250, 251 and squeegee members 252, 254 can require approximately 15 newtons per linear foot to be compressed by the magnitudes noted above, one-quarter of an inch for the brush members 250, 251 and one-eighth of an inch for the squeegee members 252, 254. Thus, in some embodiments, the total weight of the cleaning device 200 is adjusted to provide enough force to provide compression of all the brush members and squeegee members included in all of the included cleaning modules, for example, first and second cleaning modules 204, 206. Wheels 270 can be mounted at a spacing 266 to limit the compression of the brushes 250, 251 and squeegees 252 and 254 during use.

With continued reference to FIG. 4, the second cleaning module 206 can be constructed with essentially the same components as the first cleaning module 204. More specifically, the second cleaning module 206 can include one or more brush members 250, 251, and/or one or more squeegee members 252, 254 sized and orientated to clean the receivers 160 during use. The function and deflections, and construction of the second cleaning module 206 thus is not repeated.

As noted above with reference to FIG. 4, the cleaning device 200 can also include a guide assembly 208. In some embodiments, the guide assembly can include one or more rollers 270 configured to guide the cleaning device 200 during use. In the illustrated embodiment, as shown in FIG. 4, the roller 270 is mounted between the brush member 250 and the squeegee members 252, 254. However, as shown in FIG. 6, optionally, the roller 270 can be mounted upstream from the brush 250, or downstream from the squeegees 252, 254. Additionally, the cleaning device 200 can include a plurality of rollers 270 including any combination of the positions illustrated in FIGS. 6 and 7.

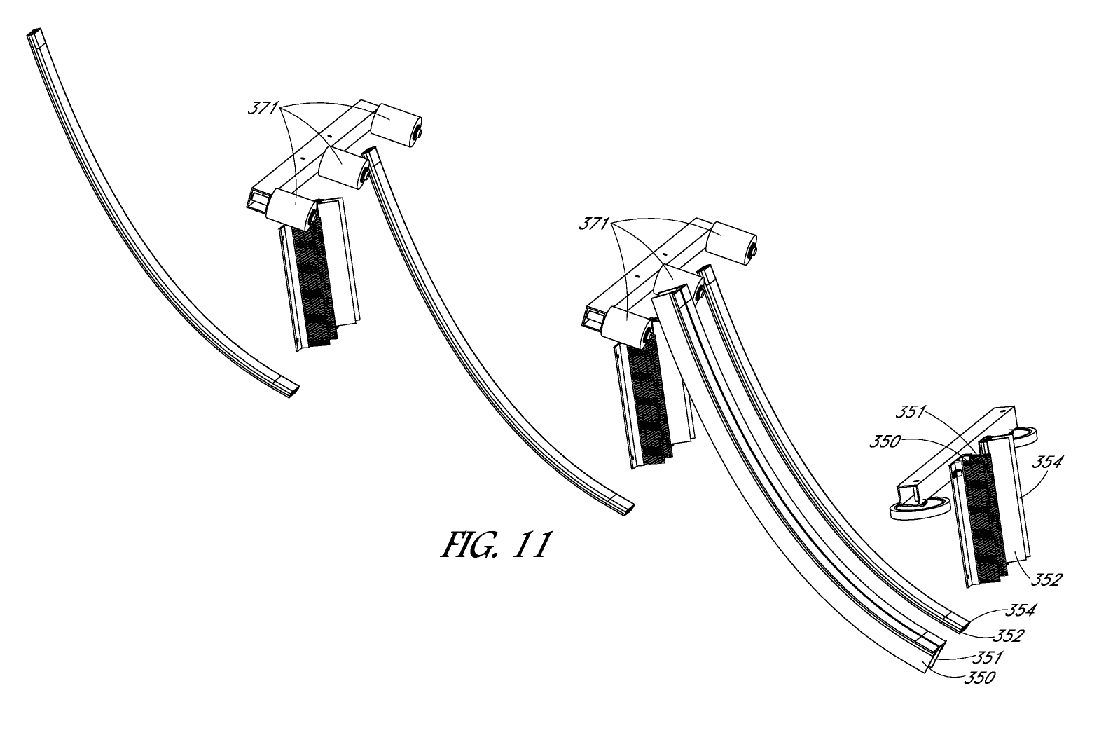

In the illustrated embodiment, the rollers 270 are positioned to roll directly on the surface of the concentrators 140. However, in other embodiments, the rollers 270 can be arranged to roll along the top edge of a concentrator 140, described in greater details below with reference to the embodiment of FIGS. 10-14.

With continued reference to FIGS. 4 and 5, the liquid delivery system 212 can include a plurality of liquid delivery hoses 272 configured to provide a supply of cleaning liquids, such as water, water mixed with detergent, or other liquids, for enhancing a cleaning action of the cleaning modules 204, 206.

With reference to FIGS. 6 and 7, the fluid delivery lines 272 can be connected, with any known structure, with one or more sprayer heads. For example, as shown in FIG. 6, the cleaning device 200 can include one or more cleaning heads 274 located upstream of the brush member 250 or brush member 251. Optionally, the fluid delivery system 212 can include one or more sprayer heads 276 disposed downstream from the brush member 250 and upstream from the first squeegee member 252. Optionally, the spray head 276 can be disposed between brush members 250, 251. Additionally, the liquid delivery system can include one or more sprayer heads 278 disposed downstream from the first squeegee member 252. Optionally, the spray heads 278 can be disposed between the squeegee members 252, 254. Optionally, the sprayer head 274, 276, 278, or any other spray heads, can be mounted to a manifold or a spray rail, along with a plurality of additional spray heads disposed along the lengths of the brush member 250 and/or the squeegees 252, 254. The spray heads and liquid delivery lines 272 can be configured to provide a desired flow rate of liquid for cleaning.

The second cleaning module 206 can include the same or similar arrangement of brushes 250, 251 and/or squeegees 252, 254. Additionally, the second cleaning module 206 can be guided in the proper or desired direction of movement with one or more wheels and/or rollers, 270.

Optionally, the guide mechanism 208 can include additional guides 271 mounted to the cross member 240. The additional rollers 271 can be configured to ride along the top edge of receivers 160, for providing additional support and alignment of the cleaning device 200 during use.

As noted above, the second cleaning module 206 can be configured to clean the surface of the receivers 160 simultaneously as the first cleaning module 204 is cleaning the surfaces of the concentrators 140. Thus, the second cleaning module 206 can be configured with the same alignment and compression characteristics as those described above with regard to the first cleaning module 204 and with reference to FIGS. 6 and 7.

With continued reference to FIG. 4, the handle assembly 210 can include a handle member 290 and a multi-axis joint 292. The handle 290 can be in the form of a pole or rod having any desired length, which provides for convenient and manipulable control over the movement of the cleaning device 200 during use. The joint 292 can be in the form of a universal joint or any other type of multi-axis joint.

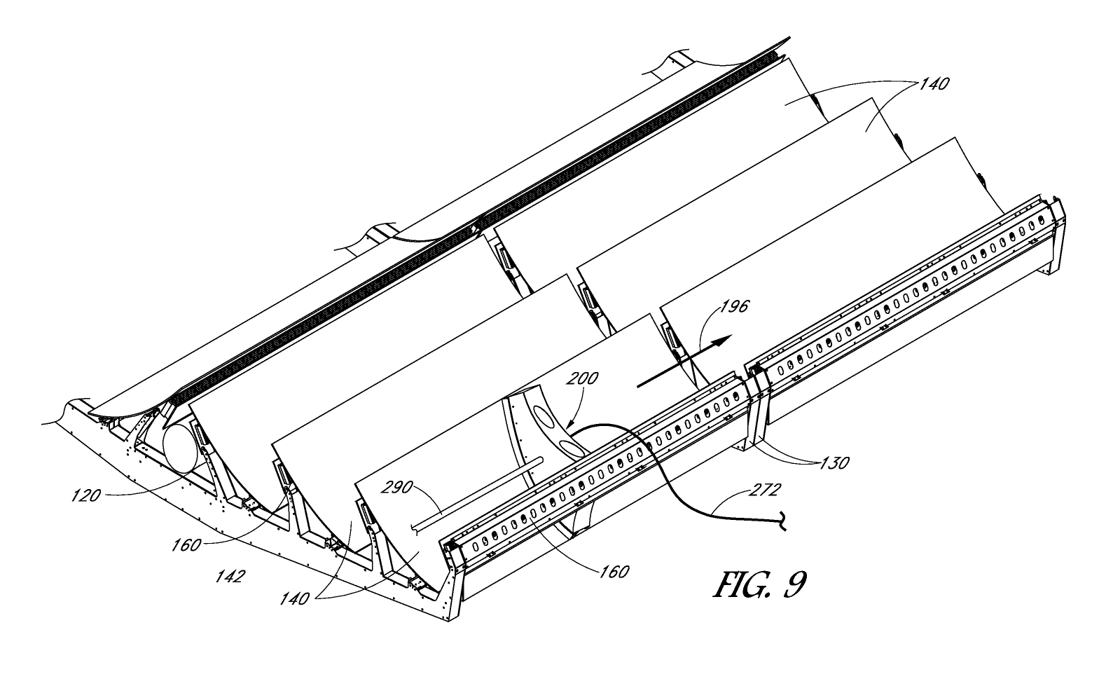

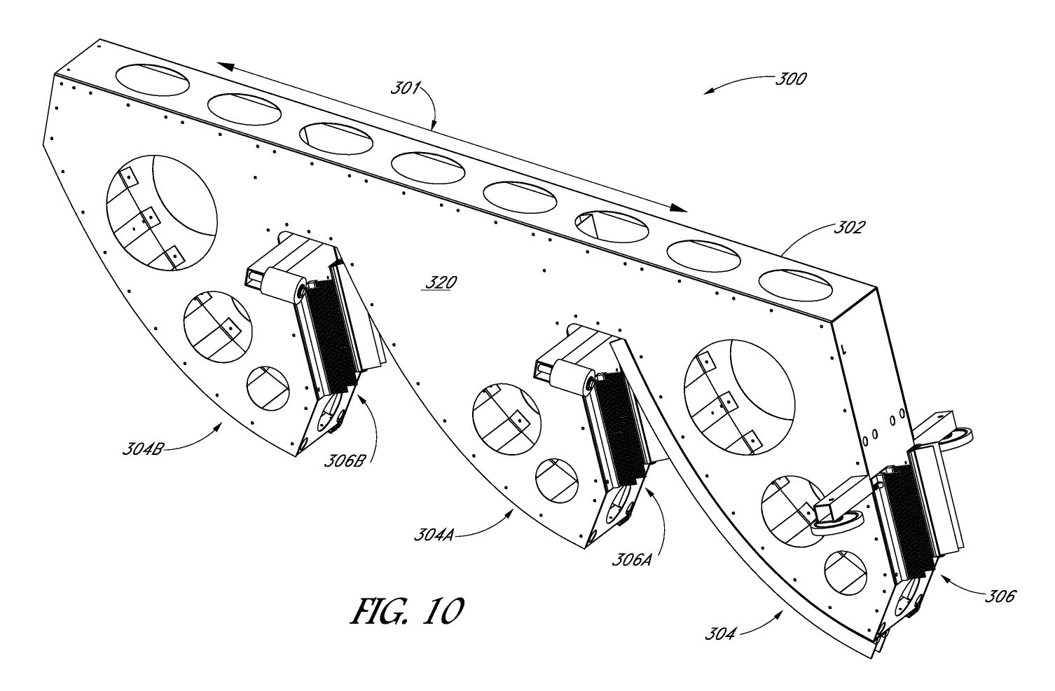

With reference to FIGS. 8 and 9, during use, the cleaning device 200 can be placed on the upper surfaces of concentrators 140 with the first cleaning module 204 facing the upper surface of the concentrators 140 and with the second cleaning module 206 in contact with the outer surface of the receivers 160. Additionally, the rollers 270 can be in contact with the upper surface of the receiver 140 and the receiver 160. Optionally, the guide rollers 271 can be in contact with an upper edge of the receivers 160.

Positioned as such, as shown in FIG. 9, the cleaning device 200 can be pushed in the direction 196 while liquid, such as water, is delivered to the liquid delivery hoses 272 for delivering water to the sprayer heads 274, 276, 278 and thereby simultaneously clean the concentrators 140 and the receivers 160. Movement along the direction 196 can be considered a cleaning movement of the cleaning device 200. In some embodiments, the liquid delivery hoses 272 can be connected to a water tank on a moveable vehicle, such as a truck, and optionally a pump (not shown) for delivering water and or other fluids to the cleaning device 200. In such a manner of operation, the truck can be driven alongside a solar system 100 while a worker pushes the cleaning device 200 with the handle 290.

FIGS. 10-14 illustrate a modification of the cleaning device 200 and is identified generally by the reference numeral 300. The components and features of the cleaning device 300 that are the same or similar to the cleaning device 200 are identified with the same reference numeral, except that a value of 100 has been added to those reference numerals.

With reference to FIG. 10, the cleaning device 300 is configured to support a plurality of pairs of first and second cleaning modules 304, 306. With reference to FIG. 10, the pair of first and second cleaning modules 304, 306 illustrated furthest to the right as viewed in FIG. 10 are labeled with reference numerals 304, 306. The middle pair of cleaning modules are identified by the reference numerals 304A, 306A and the pair of cleaning modules furthest to the left (as viewed in FIG. 10) are identified with the reference numerals 304B, 306B. The frame 302 can be considered as extending in a longitudinal direction 301 of the frame 302 which would extend generally transverse to the direction 396 of the cleaning movement, as well as the longitudinal directions of the concentrators 140, described below with reference to FIG. 14. As such, with any combination of two of the cleaning modules 304, 304A, 304B, the cleaning device 300 can be considered to serve as means, supported by the frame member, for simultaneously cleaning a plurality of solar concentrating reflectors 140 having parallel longitudinal axes, with a single movement of the frame member 302 in a direction 396 parallel to the longitudinal axes of the concentrators 140. Additionally, further including a combination of two of the cleaning modules 306, 306A, 306B, the cleaning device 300 can be considered as serving as means, supported by the frame member, for simultaneously cleaning a plurality of solar concentrating reflectors 140 and a plurality of solar energy receivers 160 with a single cleaning movement of the frame member 302.

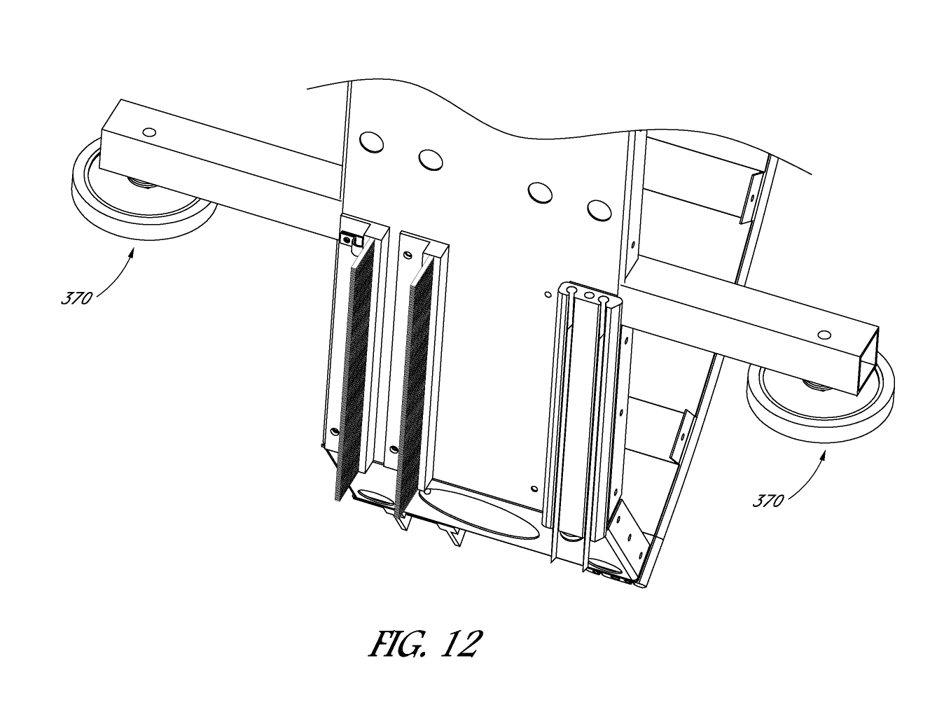

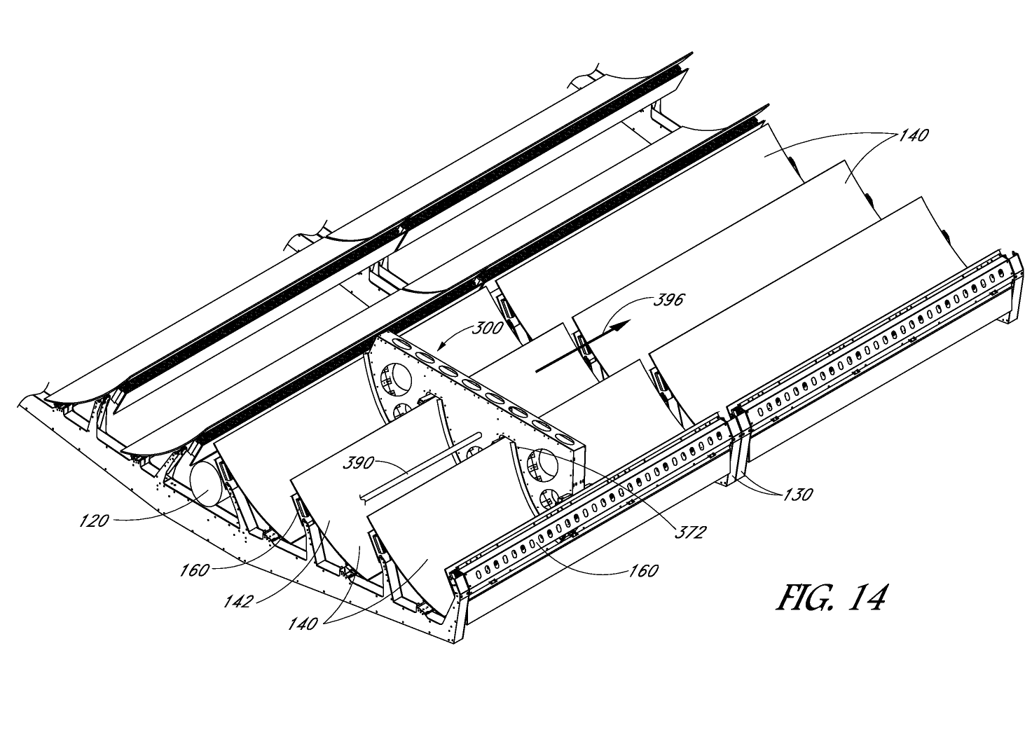

As explained above with reference to FIGS. 6 and 7, each of the brushes 350, 351 and squeegees 352, 354 included in each of the first and second cleaning modules 304, 306, can be configured to operate desirably with approximately about 15 newtons of force per linear foot so that the respective brushes and squeegee members are compressed to the desired degree. Thus, the weight of the entire cleaning device 300, in order to provide the desired compression, can be adjusted to provide the desired forces, which can be significantly heavier than the cleaning device 200. Thus, in order to sufficiently support the additional weight of the cleaning device 300, with reference to FIG. 11, the cleaning device 300 can include two sets of three rollers 371 configured to ride along the top edge of concentrators 140 (described in greater detail below with reference to FIGS. 13 and 14). As such, during use, the rollers 371 can better distribute the total weight of the cleaning device 300 and avoid undesirable load concentrations on the concentrators 140.

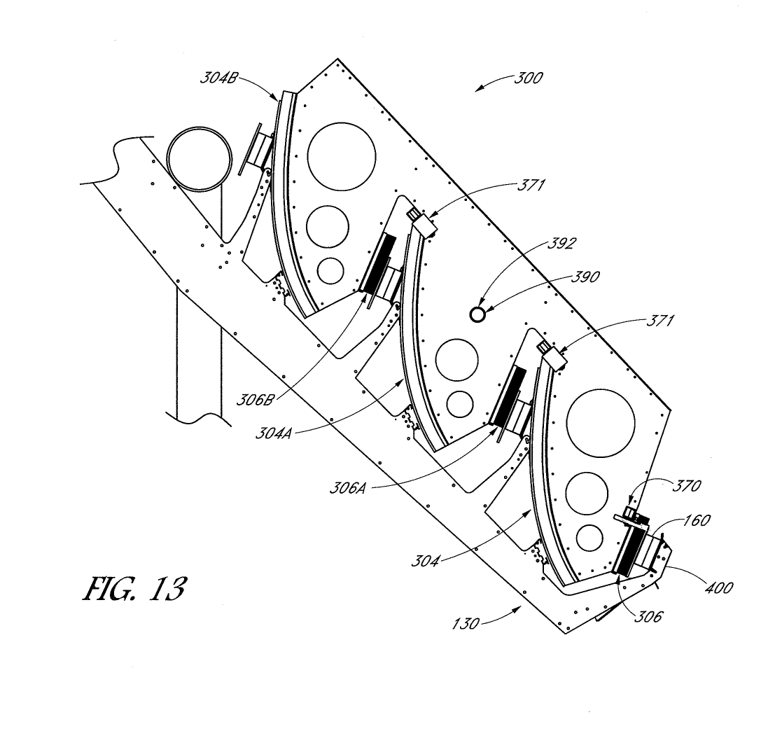

With reference to FIGS. 13 and 14, during use, the cleaning device 300 can be placed onto a solar collection system such that the three pairs of first and second cleaning modules 304, 306, 304A, 306A, 304B, 306B are in contact with respective three pairs of concentrators 140 and receivers 160. Additionally, the rollers 371 can be positioned to ride along a top edge of two rows of concentrators 140. Further, the rollers 370 (FIG. 12) can be positioned so as to ride along a front face of a receiver 160.

Further, with reference to FIG. 13, in order to provide a more convenient angle for manipulation of the handle 390, the solar system can be tilted to an angle, for example, about 50 degrees, to make it more convenient for a user to place the cleaning device 300 into the desired orientation onto the solar system device.

In such a configuration, the total weight of the cleaning device 300, under the force of gravity, can generate significant loads onto receivers 160. Thus, in the illustrated embodiment, the rollers 370 are only provided on the rightmost (as viewed in FIG. 13) portion of the cleaning device 300. As such, some of the weight of the cleaning device 300 as well as some of the forces generated by the compression of brushes and squeegees on the first cleaning modules 304, 304A, 304B, is carried by the rollers 370 on the front face of the receivers 160 mounted on the outermost portion of the solar collection device. This is significant because some of the receivers 160 can be mounted directly to the backs of concentrators 140. However, the outermost receiver 160 (furthest to the right as viewed in FIG. 13) is not mounted to a concentrator 140. Rather, the rightmost or outermost receiver 160 is mounted to a separate support arm 400, which is directly connected to the support 130 of the solar collection device. As such, relying on the outermost receiver 160 for supporting additional loads generated by the cleaning device 300 does not risk damage to concentrators 140 which have receivers 160 mounted to the backs thereof.

With reference to 14, during use, the cleaning device 300 can be pushed in the direction of arrow 396, with the use of the handle 390. Additionally, although not shown, liquid delivery device hoses can be connected to the various included sprayer heads described above with reference to the cleaning device 200 for delivering liquid during cleaning Additionally, a supply of cleaning liquid can be attached to such liquid delivery devices for delivering liquid during use. For example, a truck including a cleaning fluid reservoir and one or more pumps can be driven alongside of the solar energy device during cleaning.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features.

What is claimed is:

1. A concentrated solar energy collector cleaner, comprising:
a frame member;
a first cleaning module supported by the frame member, the first cleaning module including at least a first debris displacing member having a first cleaning surface extending along a curved shape;
a first guide member configured to support the frame member during a cleaning movement of the cleaner with the first cleaning surface of the first debris displacing member in contact with a first curved reflective surface of a first solar concentrator.

2. The cleaner according to claim 1, wherein the first guide member is positioned to support the frame member in a predetermined position during the cleaning movement, in which the first debris displacing member is compressed against the curved reflective surface of the solar concentrator.

3. The cleaner according to claim 1, wherein the first debris displacing member comprises a brush or a squeegee.

4. The cleaner according to claim 1, additionally comprising a first fluid spraying head supported by the frame.

5. The cleaner according to claim 1, additionally comprising a second debris displacing member supported by the frame, the first debris displacing member comprising a brush and the second debris displacing member comprising a squeegee, both the first and second debris displacing members having a curved shape.

6. The cleaner according to claim 1 additionally comprising a second debris displacing member supported by the frame, the first and second debris displacing members extending in different directions.

7. The cleaner according to claim 6, wherein the second debris displacing member comprises a second cleaning surface extending along a straight shape.

8. The cleaner according to claim 6, wherein the second debris displacing member comprises a second cleaning surface is arranged to contact a solar energy receiver associated with the solar concentrator, during the cleaning movement.

9. The cleaner according to claim 6, wherein the first debris displacing member is mounted to a first side of the frame member, and wherein the second debris displacing member is mounted to a second side of the frame member which is spaced from the first side.

10. The cleaner according to claim 1 additionally comprising a second cleaning module supported by the frame member, the second cleaning module including a second debris displacing member having a second cleaning surface extending along the curved shape.

11. The cleaner according to claim 10, wherein the second cleaning module supported by the frame in a position with the second debris displacing member in contact with a second solar concentrator spaced from the first solar concentrator and extending parallel to the first solar concentrator.

12. The cleaner according to claim 11, additionally comprising a third cleaning module separate from the first and second cleaning modules supported by the frame in a position disposed between the first and second cleaning modules.

13. The cleaner according to claim 12, wherein the third cleaning module includes a third debris displacing member extending in a non-curved shape.

14. The cleaner according to claim 12, wherein the third cleaning module is positioned such that the third debris displacing member contacts the surface of a solar energy receiver disposed between the first and second solar concentrators, during the cleaning movement.

15. A concentrated solar energy collector cleaner, comprising:
a frame member extending along a longitudinal direction;
a first cleaning module supported by the frame member, the first cleaning module including at least a first debris displacing member having a first cleaning surface extending along a first curved shape; and
a second cleaning module supported by the frame member, the first cleaning module including at least a second debris displacing member having a second cleaning surface extending along a second curved shape;
wherein the first and second cleaning modules are spaced from each other along the longitudinal direction.

16. The cleaner according to claim 15 additionally comprising a first guide member configured to support the frame member during a cleaning movement of the cleaner with the first and second cleaning surfaces in contact with curved reflective surfaces of a first and second solar concentrators extending parallel to each other, respectively.

17. The cleaner according to claim 15 additionally comprising third and fourth cleaning modules having third and fourth cleaning surfaces, respectively, the third and fourth cleaning modules being spaced from each other and the first and second cleaning modules, along the longitudinal direction.

18. The cleaner according to claim 15, wherein each of the first and second cleaning modules each comprise a plurality of debris displacing members.

19. The cleaner according to claim 15, wherein the first and second curved shapes correspond to a sunlight concentrating geometry.

20. A concentrated solar energy collector cleaner, comprising:
a frame member;
means, supported by the frame member, for simultaneously cleaning a plurality of solar concentrating reflectors having parallel longitudinal axes, with a single movement of the frame member in a direction parallel to the longitudinal axes.
